(19) United States
(12) Patent Application Publication
(10) Pub. No.: US 2015/0322559 A1
(43) Pub. Date: Nov. 12, 2015

(54) MULTILAYER COATINGS SYSTEMS AND METHODS

(71) Applicants: Michael Lee KILLIAN, Troy, MI (US); Richard James LESLIE, New Batimore, MI (US); Bilal Bhopal SAI, Ann Arbor, MI (US); EATON CORPORATION, Cleveland, OH (US)

(72) Inventors: Michael Lee KILLIAN, Troy, MI (US); Richard James LESLIE, New Baltimore, MI (US); Bilal Bhopal SAID, Ann Arbor, MI (US)

(21) Appl. No.: 14/648,566

(22) PCT Filed: Nov. 25, 2013
(86) PCT No.: PCT/US2013/071660

§ 371 Date: May 29, 2015

Related U.S. Application Data
(60) Provisional application No. 61/732,028, filed on Nov. 30, 2012.

(51) Int. Cl. C23C 4/10; B23K 26/34; B05D 5/08; C23C 4/12; B05D 7/14

(52) U.S. Cl. CPC C23C 4/105; C23C 4/10; C23C 4/127; B05D 7/14; B05D 5/08; B23K 26/34

(57) ABSTRACT

The present disclosure relates to multilayered coating systems and methods. The multilayered coating when applied to a metal component utilized in a marine environment provides for corrosion and/or bio-fouling resistance. The multilayered coating includes a base layer and a superhydrophobic layer.

### RELATED APPLICATIONS

This application is being filed on 25 Nov. 2013, as a PCT International Patent application and claims priority to U.S. Patent Application Ser. No. 61/732,028 filed on 30 Nov. 2012, the disclosure of which is incorporated herein by reference in its entirety.

### TECHNICAL FIELD

The present disclosure relates generally to multilayer coatings systems and methods. More particularly, the present disclosure relates to multilayer coatings systems and methods that include a superhydrophobic layer.

### INTRODUCTION

Numerous metal components such as hydraulic cylinders are exposed to water for extended periods of time without maintenance. These metal components are found in marine environments, such as submerged in saltwater, located in a sea spray zone, or located in a splash zone. However, metal components are often hindered by corrosion and bio-fouling when utilized in damp environments.

### SUMMARY

The present disclosure relates to multilayered coating systems and methods. The multilayered coating when applied to a metal component utilized in a marine environment provides for corrosion and/or bio-fouling resistance. The multilayered coating includes a base layer and a superhydrophobic layer.

In part, the disclosure describes a method for providing corrosion and bio-fouling resistance to a metal marine component. The method includes coating a metal marine component with a base layer and applying a superhydrophobic layer to the base layer.

In yet another aspect, the disclosure describes a marine metal cylinder that resists bio-fouling and corrosion. The marine metal cylinder includes a metal cylinder rod, at least one base layer coating the metal cylinder rod, and a superhydrophobic layer coating an exterior base layer.

In an additional embodiment, the disclosure describes a multilayer coating. The multilayer coating includes at least one base layer with a porosity of greater than 3% for coating a marine metal component, and a superhydrophobic layer coating an exterior base layer. The at least one base layer and the superhydrophobic layer form a multilayer coating.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclose herein are based.

### BRIEF DESCRIPTION OF THE DRAWINGS

FIG. 1 illustrates an embodiment of a partial, cross-sectional view of a multilayer coating applied to a metal component in accordance with the principles of the present disclosure;

FIG. 2 illustrates an embodiment of a method for providing corrosion and bio-fouling resistance to a metal marine component in accordance with the principles of the present disclosure; and

FIG. 3 illustrates an embodiment of a partial, cross-sectional view of a hydraulic cylinder coated in a multilayer coating in accordance with the principles of the present disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like structures.

The present disclosure relates to coatings for metal components submerged in water, located in water splash zones (or areas that are repeatedly exposed to water due to tides and waves), or located in sea spray zones. In some embodiments, the metal component includes ferrous material. Profitable long term operations, such as wave energy conversion machines or offshore drilling rigs require a number of metal components, such as large hydraulic cylinders, be submerged in saltwater for extended periods of time without maintenance. However, the undersea environment challenges the corrosion resistance and bio-fouling resistance of most metal materials. Coatings would seem to offer a viable solution, but electroplated coatings fail after only a few months of service in saltwater. Failure is usually due to seawater penetrating through a network of cracks and pores formed in the coating allowing the seawater to ultimately reach the substrate.

Plasma spray coatings have a very high hardness but poor corrosion resistance. Porosity levels of 2% to 15% limit corrosion resistance of plasma spray coatings. Numerous and inter-connected pores in the plasma spray coatings create direct paths for seawater to reach the metal substrate. Most of the plasma sprayed coatings are alumina-titania or chromia-titania ceramics.

High Velocity Oxy-Fuel Gas (HVOF) thermal spray coatings have very high hardness, but poor corrosion resistance. Porosity of 0.5 to 4.0 percent limits the corrosion resistance possible with HVOF coatings. HVOF coatings consist of hard particles like carbides embedded within a metallic binder/matrix.

Laser clad coatings like Eatonite™ L1, Nickel-based Inconel® 625, and Cobalt-based Ultimet® or Stellite® are not very hard, but are more dense exhibiting only 0.05 to 1.0 percent porosity. Even this minute amount of porosity may jeopardize a coating expected to perform for 15 years in marine environments.

Additionally, these electroplated coatings, plasma sprayed coatings, HVOF coatings, and laser clad coatings all lack resistance to bio-fouling. Bio-fouling is caused when slime, mussels, barnacles, worms, and/or other living organisms form on materials submerged in water or repeatedly exposed to water for extended periods of time.

Sealants, such as Diamant's Dichtol WFT 1532, have been used to improve the corrosion resistance of coatings by infiltrating the pores of the coatings. However, the life of the sealant is often only two to three years. A sealant may degrade because of abrasion, ultraviolet light, and moisture.

Accordingly, the multilayer coating systems and methods described herein provide metal materials with corrosion and/or bio-fouling resistance when submerged in or exposed repeatedly to water, such as saltwater. The term “saltwater” as used herein refers to any type of water that contains 0.5 to 50 grams of salt per liter (or part per million) such as seawater, brackish water, ocean water, and etc. The multilayer coating systems and methods allows metal components to be utilized in marine environments for extended periods of time without maintenance. The term “marine” refers to water environments, such as being submerged in water, located in splash zone, located in a sea spray zone, or other areas that are repeatedly exposed to water, including saltwater. The multilayer coating systems and methods utilize a base layer covered directly or indirectly with a superhydrophobic layer.

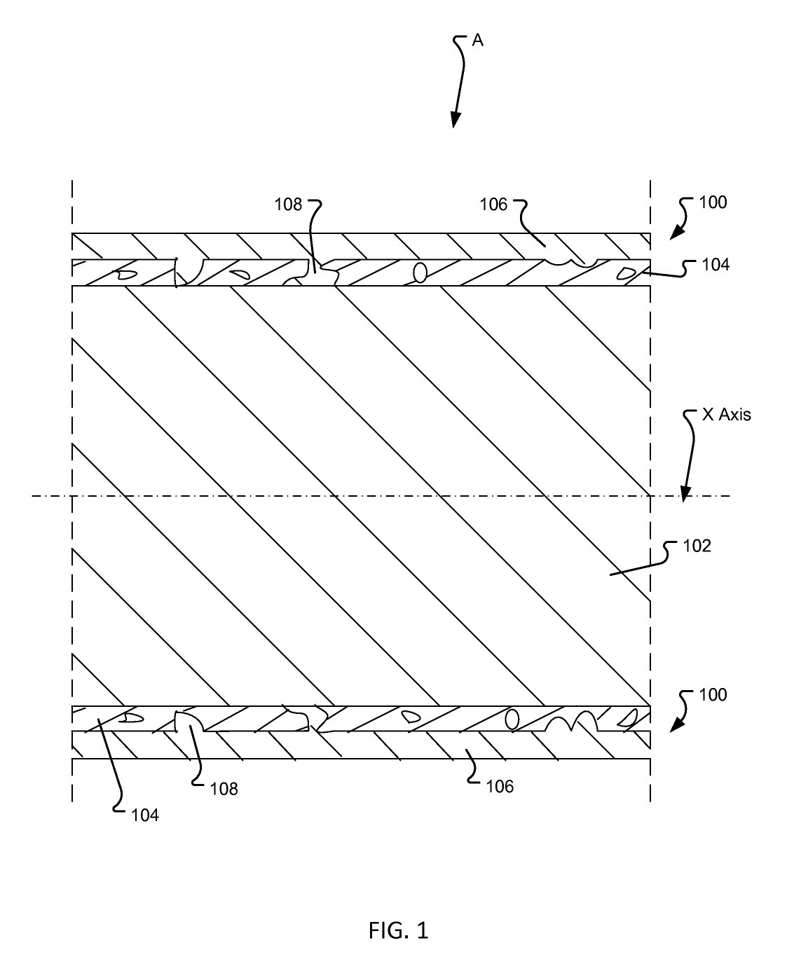

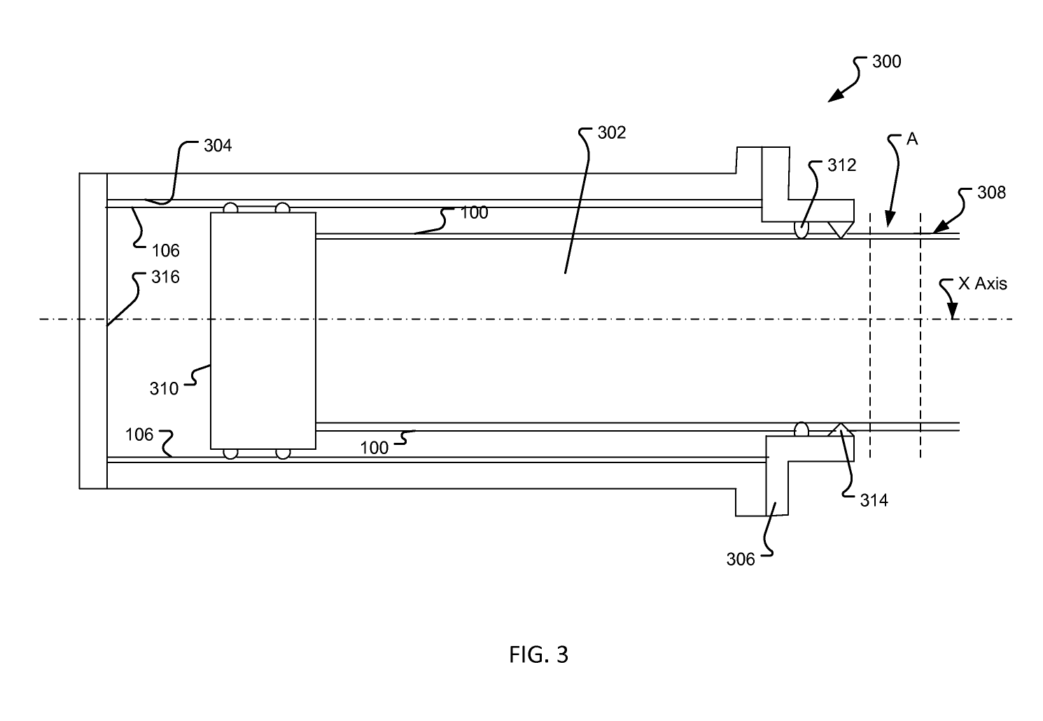

FIG. 1 illustrates an embodiment of a partial, cross-sectional view of a multilayered coating 100 as applied to a metal component 102. In one embodiment, the partial, cross-sectional view of the multilayered coating 100 is the section labeled “A” positioned with reference to the X axis as illustrated in FIG. 3. The multilayered coating 100 includes a base layer 104 and a superhydrophobic layer 106. The base layer 104 is applied to a metal component and/or substrate 102. The superhydrophobic layer 106 directly or indirectly coats the base layer 104. In some embodiments, the multilayered coating 100 includes one or more intermediate layers between the base layer 104 and the superhydrophobic layer 106. In some embodiments, the intermediate layer is at least one additional base layer 104. The superhydrophobic layer 106 directly coats the base layer 104 when it is applied directly to the base layer 104. The superhydrophobic layer 106 indirectly coats the base layer 104 when the superhydrophobic layer 106 is directly applied to an intermediate layer that directly coats the base layer 104. In embodiments with multiple base layers 104, the superhydrophobic layer 106 is applied directly to the most exterior base layer 104.

In some embodiments, the base layer 104 is a HVOF thermal sprayed coating, a plasma sprayed coating, a plasma transferred arc (PTA) coating, or a laser clad coating. Example HVOF thermal spray coating compositions include 10 Cobalt-4 Chromium-86 Tungsten Carbide (10Co-4Cr-86WC, often called WC-10Co-4Cr) or an 18 metal (nickel, cobalt, or chromium)-45 Chromium Carbide-37 Tungsten Carbide (18 metal-45 Cr3C3-37 WC). Example plasma sprayed coatings include 45 Chromium Oxide-55 Titanium Oxide (Sulzer Metco 111) or a 3 Titanium Oxide-97 Aluminum Oxide (Sulzer Metco 6203). Example laser clad coating and PTA coatings include Inconel® 625 (Nickel-based alloy), Ultimet® (a Cobalt-based coating) and Eatonite® L1 (a proprietary coating of Eaton Corporation).

The superhydrophobic layer 106 is the top coat of the multilayered coating 100. The superhydrophobic layer 106 acts as a sealer for the base layer 104 with superhydrophobic properties. The superhydrophobic layer 106 creates a surface that repels water. For example, water in contact with the superhydrophobic surface beads up at a high contact angle. The superhydrophobic layer 106 creates a surface in which water beads with a contact angle of at least 135 degrees. In some embodiments, the superhydrophobic layer 106 creates a surface in which water beads with a contact angle of at least 150 degrees and corresponding roll off angle of at least 10 degrees. In additional embodiments, the superhydrophobic layer 106 creates a surface in which water beads with a contact angle of at least 160, 165, 170, 175, or 180 degrees.

Use of a superhydrophobic layer 106 as a sealant improves the corrosion resistance and bio-fouling resistance of the base layer 104 when compared to base layers that do not utilize a superhydrophobic layer 106. The use of a superhydrophobic layer 106 over a base layer 104 repels water from the base layer 104 on a metal component or substrate 102 and hinders and/or prevents water from contacting the metal component or substrate 102. In some embodiments, the superhydrophobic layer 106 waterproofs the base layer 104 and/or the metal component 102.

For example, in some embodiments, the metal component or substrate 102 is a rod 302 of a metal hydraulic cylinder 300, as illustrated in FIG. 3. FIG. 3 illustrates an embodiment of a hydraulic cylinder 300 coated in a multilayered coating 100. The hydraulic cylinder 300 includes a piston 308 with a piston rod 302 and a piston head 310. In some embodiments, the hydraulic cylinder 300 has a stroke length from 20 feet to 50 feet. In other embodiments, the hydraulic cylinder 300 has a bore diameter from 12 inches to 60 inches. The rod 302 is covered with the multilayered coating 100 and is exposed to a marine environment. The multilayered coating 100 is water resistant or repels water because water simply runs off the surface of the rod 302 and does not reach the base layer 104, pores 108 in the base layer 104, or the metal material in the rod 302. In some embodiments, portions in addition to the rod 302 of the hydraulic cylinder 300 are coated with the hydrophobic layer 104. For example, a cylinder barrel 304, cylinder cap 306, head 310, wiper 314 and/or seal 312 of the hydraulic cylinder 300 are coated with the superhydrophobic layer 106. Further, FIG. 3 illustrates an “X axis” that runs down the center of the cylinder barrel 304.

As discussed above, the superhydrophobic layer 106 repels water providing for corrosion resistance. The term “corrosion” as used herein refers to the destruction of metal caused by a chemical reaction between the metal and the metal's environment. The superhydrophobic layer 106 repels water providing for corrosion resistance for a predetermined amount of time, such as at least 5 years, 8 years, 10 years, 12 years, or 15 years.

Further, as discussed above the superhydrophobic layer 106 provides bio-fouling resistance. The superhydrophobic layer 106 provides bio-fouling resistance because the superhydrophobic layer 106 repels water and provides self-cleaning properties. Without being bound by any particular theory, it is believed that the cause of the self-cleaning property of the coated substrate is the hydrophobic water-repellent double structure of the surface. This enables the contact area and the adhesion force between surface and droplet to be significantly reduced, resulting in a self-cleaning surface. Thus, dirt particles with a reduced contact area are picked up by water droplets and are easily cleaned off the surface. If a water droplet rolls across a contaminated surface (e.g., surface containing dirt particles), the adhesion between a dirt particle, irrespective of its chemistry, and the droplet is higher than between the particle and the surface.

Accordingly, this self-cleaning property provides for bio-fouling resistance. Essentially, the same properties that prevent dirt from accumulating on the hydrophobic layer make it difficult for living organisms to attach to the hydrophobic surface. Because the superhydrophobic layer 106 is self-cleaning, dirt, mud, snow, and ice are repelled by the superhydrophobic layer 106. Thus, the multilayer coating prevents organisms from attaching to metal components in marine environments for extended period of time, such as 2 years, 5 years, 7 years, 10 years, 12 years, and 15 years. Any material that settles on surface of the multilayered coating 100 either falls off or is easily removed from the surface of the metal substrate or device 102.

Additionally, in embodiments that apply the multilayered coating to a rod 302 of a hydraulic cylinder 300, the seal 312 and/or wiper 314 also reduce bio-fouling. The seal prevents water from entering the cylinder barrel 304 and, therefore, creates a water tight seal that rubs along the piston rod 302. The contact between the seal 312 and rod 302 scrapes off any material that attaches to the rod 302. The material is easily removed by this contact because of the self-cleaning properties of the multilayered coating 100. In some embodiments, the hydraulic cylinder 300 includes a wiper 314 that is designed to scrape material off of the piston rod 302 before the material contacts the seal 312. Therefore, the contact between the wiper 314 and rod 302 scrapes off any material that attaches to the rod 302. The material is easily removed by the wiper due to the self-cleaning properties of the multilayered coating 100. Accordingly, the constant scraping of the piston rod 302 in combination with the multilayered coating 100 provides bio-fouling resistance.

Further, in embodiments, an antifouling additive is added to the superhydrophobic coating 106. In some embodiments, the antifouling additive is a biocide, such as silicone or copper. In further embodiments, the antifouling additive is Seanine 211 as sold by Dow Chemical.

The superhydrophobic layer 106 may include water-based or solvent based formulations, which can be applied by spraying, brushing, rolling, or dipping the base layer 104 in the superhydrophobic layer 106, whether in a singular or dual step process. Further, in some embodiments, once applied, the superhydrophobic layer 106 is cured. In some embodiments, the superhydrophobic layer 106 is cured with ambient air. In other embodiments, the superhydrophobic layer 106 is cured utilizing induction heating. In further embodiments, the superhydrophobic layer 106 is cured utilizing oven convection techniques or industrial heat guns.

Previously utilized coatings attempted to minimize porosity. As discussed above, water could penetrate these pores and ultimately reach the metal component 102 reducing the effectiveness of a coating. Previously, the larger the amount of porosity in the coating utilized on the metal substrate 102, the greater the chance of corrosion. Plasma spray processes exhibit porosity content of 2% to 15%. HVOF has a porosity of 0.5 to 4%. PTA and laser clad coatings have a porosity of at most 0.05 to 1%. The PTA and laser clad coating exhibit a lower porosity than the plasma spray and HVOF coatings. However, the plasma spray and HVOF coatings are significantly harder than the PTA and laser clad coatings. For example, the plasma spray and HVOF coatings may exhibit a hardness of 900 to 1200 Vickers Hardness range (HV), while the PTA and laser clad coating may exhibit a hardness of 250 to 460 HV. The harder the coating, the better the wear and scratch resistance of the coating.

In some embodiments, in contrast to previous systems, increased porosity in the base layer 104 improves the performance of the multilayered coating 100. The superhydrophobic layer 106 may be anchored by the porosity of the base layer 104. Anchoring may improve the bond strength between the superhydrophobic layer 106 and the base layer 104. Accordingly, increased porosity in the base layer 104 is beneficial in preventing corrosion of the metal material for the multilayered coating 100. The higher the porosity of the base layer 104, the more anchoring available for the superhydrophobic layer 106 resulting in a high bond strength between the superhydrophobic layer 106 and the base layer 104. In some embodiments, the strong bond created by a higher porous base layer 104 will prevent or reduce the multilayered coating 100 from being affected by wear created by years of use (e.g., rod 302 sliding in and out of a seal stack). Further this strong bond strength may provide for a superhydrophobic coating 106 that is more uniformly distributed after years of wear when compared to multilayered coatings that utilized base layers 104 with lower porosity.

Therefore, the superhydrophobic layer 106 also provides for wear resistance. For example, the superhydrophobic layer 106 makes harder base layers, such as HVOF, that typically exhibit a higher porosity and poor corrosion resistance suitable for use in marine environments. Accordingly, not only do the multilayered coatings 100 provide better corrosion and/or bio-fouling resistance than previously utilized marine coatings, in some embodiments, the multilayered coating are also harder than the previously utilized marine coatings providing better wear resistance than found in previously utilized marine coatings.

Because of the benefits provided by a high porosity, in some embodiments, the base layer 104 is manipulated to increase porosity. Porosity can be varied by selection of the coating process. For example, porosity in thermal spray and laser/PTA clad coatings can be increased deliberately to provide additional sites for superhydrophobic layer infiltration of the surface. Plasma spray processes can increase the amount of porosity in the coating by running an excessive stand-off distance between the metal component 102 and the spraying torch orifice. Small quantities of reactive gases, such as Oxygen or Nitrogen at 2%, for example, can be blended into the inert shielding gas mixture to increase porosity. Electrical parameter voltage and current can also be manipulated to increase porosity in the plasma spray coating. Further, in some embodiments, HVOF gas pressures and flow rate are modified to increase porosity. In other embodiments, shielding gas flow rate are diminished in laser cladding and in PTA deposition to increase porosity. For example, the HVOF thermal sprayed coating, the plasma sprayed coating, the plasma transferred arc (PTA) coating, or the laser clad coating can all be manipulated until a porosity of at least 5% is reached. Accordingly, base layers with lower porosity, such as laser clad coating may be manipulated to get a desired porosity of at least 2%, 3%, 4% or 5%.

However, the superhydrophobic layer 106 may be utilized on base layers 104 with various porosities. In some embodiments, the porosity of the base layer 104 is at least 0.05%. In some embodiments, the porosity of the base layer 104 is at least 1%. In other embodiments, the porosity of the base layer 104 is at least 2%. In some embodiments, the porosity of the base layer 104 is at least 3%, 4%, or 5%. In some embodiments, the porosity is of the base layer 104 is from 0.05% to 5%, 0.05% to 1%, 0.05% to 2%, 0.05% to 3%, 1% to 5%, from 2% to 5%, from 3% to 5%, from 4% to 5%, from 1% to 4%, from 1% to 3%, from 1% to 2%, from 2% to 4%, from 2% to 3%, or from 3% to 4%. It is appreciated that while the porosity percentages of the HVOF thermal sprayed coating, the plasma sprayed coating, the PTA coating, or the laser clad coating cannot be decreased from the ranges described above, each of them can be manipulated to increase their porosity to at least 5%.

In one embodiment, a base layer 104 of Hastelloy® C276 (Carpenter MicroMelt® C276) and Chromium Carbide is applied to a metal substrate, for example, a hydraulic cylinder rod, by utilizing HVOF thermal spraying. The ratio of binder to hard particle in the base layer was 40:60 (20:30). HVOF spraying parameters are manipulated to deposit a base layer over the metal substrate with a porosity of 5%. With the base layer clean and dry, a superhydrophobic layer is applied to the base layer. Because of the superhydrophobic layer's low viscosity, the superhydrophobic layer readily infiltrates the numerous pores formed in the base layer. Ambient air or induction heating is utilized to cure the superhydrophobic layer.

In the repair or reclamation capacity, the superhydrophobic layer may be applied periodically as needed. In one embodiment, the reclamation period is 2 years. For example, a metal component already in use in a marine environments for two years or less, but only coated with a base layer, may be coated with the superhydrophobic layer to increase the lifespan of the metal component.

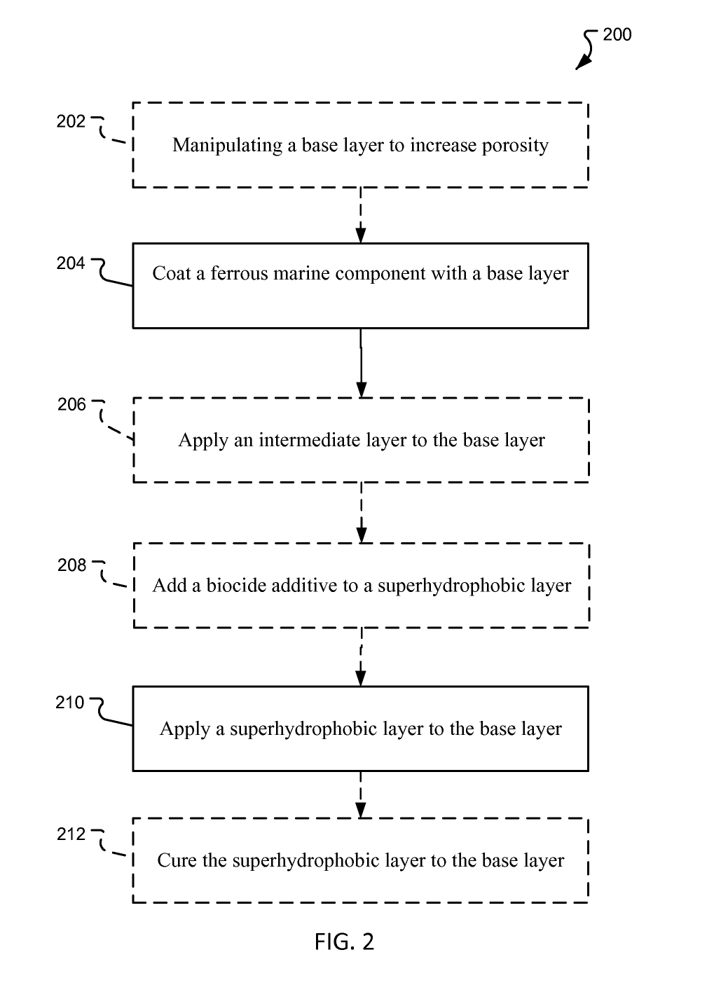

FIG. 2 illustrates an embodiment of a method 200 for providing corrosion and bio-fouling resistance to a metal marine component. In some embodiments, the metal marine component is a hydraulic cylinder, a rod for the hydraulic cylinder, a wave energy conversion device, or a filter.

As illustrated, method 200 includes a coating operation 204. During the coating operation 204, method 200 coats a marine metal component or substrate with a base layer. The base layer as described above is a HVOF thermal sprayed coating, a plasma sprayed coating, a plasma transferred arc (PTA) coating, or a laser clad coating.

In some embodiments, method 200 includes a manipulation operation 202. During manipulation operation 202, method 200 manipulates the base layer to increase the porosity of the base layer. Various porosities may be utilized in the base layer as described above. Porosity can be varied by selection of the coating process. Various processes may be utilized to increase the porosity of the base layer as described above.

Next, method 200 includes an applying operation 210. During the applying operation 210, method 200 applies a superhydrophobic coating to the base layer. In some embodiments, the applying operation 210 is performed by method 200 after the base layer is clean and dry. The super hydrophobic layer may be applied directly or indirectly to the base layer. The superhydrophobic layer is applied by spraying, brushing, rolling, and/or dipping the base layer in the superhydrophobic layer. In some embodiments, the superhydrophobic coating is applied in a singular or dual step process.

Further, in some embodiments, method 200 includes a curing operation 212. During the curing operation 212, method 200 cures the superhydrophobic layer. As discussed above there are numerous ways to cure the superhydrophobic layer, such as utilizing ambient air or induction heating.

The superhydrophobic layer acts as a sealer for the base layer with superhydrophobic properties. The superhydrophobic layer creates a surface that repels water. The surface repels water by creating water beads with a contact angle of at least 135 degrees. In some embodiments, the superhydrophobic layer creates a surface that produces water beads with a contact angle of at least 180 degrees.

Use of a superhydrophobic layer as a sealant improves the corrosion resistance and bio-fouling resistance of the marine metal component when compared to marine metal components that do not utilize a superhydrophobic layer. The use of a superhydrophobic layer over a base layer repels water off of the base layer on a metal component or substrate and prevents and/or hinders water from contacting the metal component or substrate. In some embodiments, the superhydrophobic layer waterproofs the base layer and/or the metal component. The superhydrophobic layer provides numerous benefits and properties, such as self-cleaning, wear resistance, bio-fouling resistance, and corrosion resistance as described above.

Additionally, in some embodiments, method 200 includes an antifouling operation 208. Method 200 during the antifouling operation 208 adds an antifouling additive to the superhydrophobic coating. The additive is added to the composition of the superhydrophobic coating prior to performance of the applying operation 210 and the curing operation 212.

In further embodiments, method 200 includes an intermediate coating operation 206. During the intermediate coating operation 206, method 200 applies at least one intermediate coating on the base layer. In some embodiments, the intermediate layer is at least one additional base layer. In these embodiments, the superhydrophobic layer is applied to the intermediate layer and indirectly applied to the base layer during applying operation 210. If multiple base layers/intermediate coatings are applied to the marine metal component during intermediate coating operation 206, then the hydrophobic layer is applied to the most external base layer/intermediate coating during applying operation 210.

### Example

Recent test data suggests that superhydrophobic layers provide a sealing solution to form the triad layer of protection for laser cladding material. Critical crevice or critical pitting temperature testing under the ASTM G48/G61 using anodic polarization techniques suggests that certain superhydrophobic formulations can withstand temperatures of (80 degrees Celsius) similar to that of Inconel 625 prior to showing signs of metastable and stable pitting (85 degrees Celsius) under galvanic cell conditions using a 3.5% NaCl solution. Additional salt for testing under ASTM B117 suggests that certain superhydrophobic formulations can easily meet 1,200 hours of testing and show little degradation in terms of creep from scribe (ASTM D1654), blister (ASTM D714-87), and rust (ASTM D610-81) and outperform in most cases, current conformal paints.

The above specification provides examples of how certain inventive aspects may be put into practice. It will be appreciated that the inventive aspects can be practiced in other ways than those specifically shown and described herein without departing from the spirit and scope of the inventive aspects of the present disclosure.

1. A method for providing corrosion and bio-fouling resistance to a metal marine component, comprising:
coating a metal marine component with a base layer; and
applying a superhydrophobic layer to the base layer.

2-15. (canceled)

16. A marine metal hydraulic cylinder that resists bio-fouling and corrosion, comprising:
a metal cylinder rod;
at least one base layer coating the metal cylinder rod; and
a superhydrophobic layer coating an exterior base layer.

17. The marine metal cylinder of claim 16, wherein the superhydrophobic layer produces water beads with a surface angle of at least 150 degrees.

18. The marine metal cylinder of claim 16, wherein the superhydrophobic layer produces water beads with a surface angle of at least 170 degrees.

19. The marine metal cylinder of claim 16, wherein the base layer is selected from a following group of coatings: a high velocity oxy-fuel gas (HVOF) thermal spray coating, plasma sprayed coating, a plasma transferred arc (PTA) coating, and a laser clad coating.

20. The marine metal cylinder of claim 16, wherein the base layer has a porosity of at least 1%.

21. The marine metal cylinder of claim 16, wherein the base layer has a porosity of at least 4%.

22. The marine metal cylinder of claim 16, wherein the marine metal cylinder is at least one of submerged in saltwater during use and repeatedly exposed to saltwater during use.

23. The marine metal cylinder of claim 16, wherein the superhydrophobic layer resists bio-fouling.

24. The marine metal cylinder of claim 16, wherein the superhydrophobic layer resists corrosion.

25. The marine metal cylinder of claim 16, wherein at least one of a barrel, base, head, piston, and seal are coated in the superhydrophobic layer.

26. A multilayer coating, comprising:
at least one base layer with a porosity of greater than 3% for coating a marine metal component; and
a superhydrophobic layer coating an exterior base layer,
wherein the at least one base layer and the superhydrophobic layer form a multilayer coating.

27. The multilayer coating of claim 26, wherein the multilayer coating provides bio-fouling resistance to the marine metal component.

28. The multilayer coating of claim 26, wherein the multilayer coating provides corrosion resistance to the marine metal component.

29. (canceled)

30. (canceled)

31. The multilayer coating of claim 26, wherein the superhydrophobic layer produces water beads with a surface angle of at least 150 degrees.

32. The multilayer coating of claim 26, wherein the superhydrophobic layer produces water beads with a surface angle of at least 170 degrees.

33. The multilayer coating of claim 26, wherein the base layer is selected from a following group of coatings: a high velocity oxy-fuel gas (HVOF) thermal spray coating, plasma sprayed coating, a plasma transferred arc (PTA) coating, and a laser clad coating.

34. The multilayer coating of claim 26, wherein the base layer has a porosity of at least 4%.

35. The multilayer coating of claim 26, wherein the base layer has a porosity of at least 5%.

36. The multilayer coating of claim 26, wherein the marine metal component is at least one of submerged in saltwater during use and repeatedly exposed to saltwater during use.
